(19) United States
(12) Patent Application Publication
(10) Pub. No.: US 2008/0227048 A1
(43) Pub. Date: Sep. 18, 2008

(54) Preformed teeth guard

(76) Inventor: Ghani Tjikueni, Baker, LA (US)

Correspondence Address: JAMES RAY & ASSOCIATES, 2640 PITCAIRN ROAD, MONROEVILLE, PA, 15146, US

(21) Appl. No.: 11/725,034

(22) Filed: Mar. 16, 2007

(51) Int. Cl. A61C 3/00

(52) U.S. Cl. 433/6

(57) ABSTRACT

A preformed teeth guard that protects teeth having sensitivity to hot and cold consumables and prevents teeth from becoming stained and accumulating harmful particles thereon and therebetween while drinking and eating. The teeth guard includes upper and lower plate members substantially conforming to a shape of each individual tooth of upper and lower rows of teeth, respectively, of a predetermined individual for press fitting onto and shielding such upper and lower rows of teeth of such predetermined individual.

### FIELD OF THE INVENTION

The present invention relates, in general, to devices used to maintain healthy teeth and, more particularly, the invention relates to a preformed teeth guard worn when drinking or eating consumables that protects the teeth of the wearer by not allowing the potentially damaging substances consumed to contact the teeth of the wearer.

### BACKGROUND OF THE INVENTION

Devices used to clean and preserve teeth after meals such as a toothbrush, toothpaste and dental floss have been in existence for many years prior to the conception and development of the present invention, as is generally well known in the prior art. These devices are designed to remove harmful substances left on and between the outer surfaces of teeth after drinking and eating.

However, to be effective, each of the above mentioned devices must be used to remove the substances left on and between teeth after meals, which can be a time consuming process. Also, these devices do not help those who have teeth sensitive to hot or cold food items.

### SUMMARY OF THE INVENTION

The present invention provides a preformed teeth guard for protecting teeth having sensitivity to hot or cold consumables and preventing teeth from becoming stained and accumulating harmful particles thereon and therebetween while drinking and eating. The preformed teeth guard includes an upper plate member that substantially conforms to a shape of each individual tooth of an upper row of teeth of a predetermined individual for press fitting onto and shielding such upper row of teeth. A substantially horizontal lower wall portion of the upper plate member abuts against a bottom surface of each individual tooth of such upper row of teeth. A substantially vertical first side wall portion of such upper plate member extends upwardly from one edge of the lower wall portion for abutting against an inner surface of each individual tooth of such upper row of teeth. A substantially vertical second side wall portion of the upper plate member extends upwardly from other edge of such lower wall portion for abutting against an outer surface of each individual tooth of the upper row of teeth. There is a lower plate member that substantially conforms to a shape of each individual tooth of a lower row of teeth of such predetermined individual for press fitting onto and shielding the lower row of teeth. A substantially horizontal upper wall portion of the lower plate member abuts against a top surface of each individual tooth of such lower row of teeth. A substantially vertical first side wall portion of such lower plate member extends downwardly from one edge of such upper wall portion for abutting against an inner surface of each individual tooth of the lower row of teeth. A substantially vertical second side wall portion of the lower plate member extends downwardly from other edge of such upper wall portion for abutting against an outer surface of each individual tooth of the lower row of teeth.

### OBJECTS OF THE INVENTION

It is, therefore, one of the primary objects of the present invention to provide a preformed teeth guard that prevents food particles from lodging on and between teeth while eating.

Another object of the present invention is to provide a preformed teeth guard that prevents substances in food and drink from staining teeth.

Yet another object of the present invention is to provide a preformed teeth guard that protects teeth from sensitivity to hot or cold consumables.

Still another object of the present invention is to provide a preformed teeth guard that is easy to use and clean when not in use.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of upper and lower plate members of a preformed teeth guard according to the present invention;

FIG. 2 is a perspective view of the upper and lower plate members of the preformed teeth guard, illustrated in FIG. 1, placed on upper and lower rows of teeth; and

FIG. 3 is a perspective view of a container for storing reusable upper and lower plate members when not in use.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

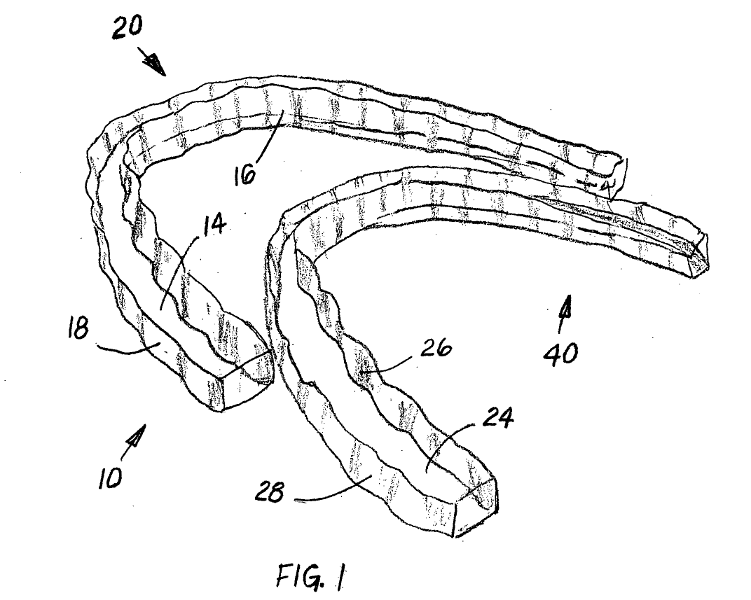

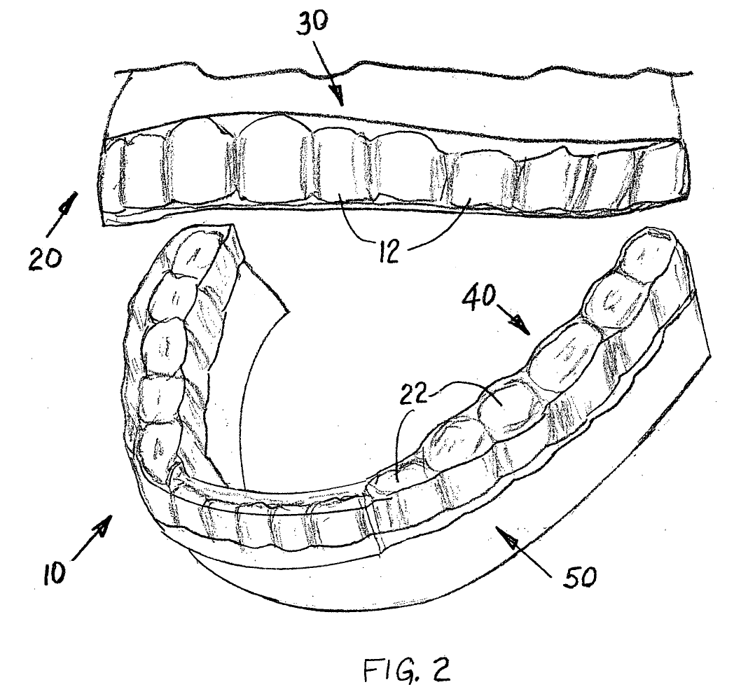

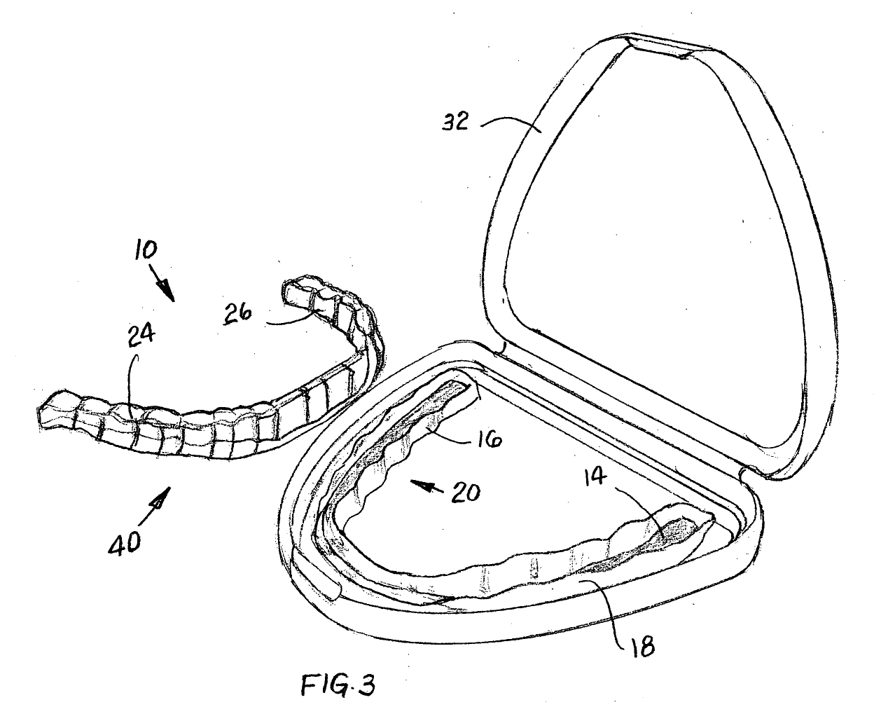

Reference is now made, more particularly, to drawing FIGS. 1 through 3. Illustrated therein is a preformed teeth guard, generally designated 10, for protecting teeth having sensitivity to hot or cold consumables and preventing teeth from becoming stained and accumulating harmful particles thereon and therebetween while drinking and eating. The teeth guard 10 includes an upper plate member, generally designated 20, that substantially conforms to the shape of each individual tooth 12 of an upper row of teeth, generally designated 30, of a predetermined individual (not shown) for press fitting onto and shielding the upper row of teeth 30 of such predetermined individual.

The upper plate member 20 includes a substantially horizontal lower wall portion 14 for abutting against a bottom surface of each tooth 12 of the upper row of teeth 30. A substantially vertical first side wall portion 16 extends upwardly from one edge of the lower wall portion 14 for abutting against an inner surface of each individual tooth 12 of the upper row of teeth 30, and a substantially vertical second side wall portion 18 extends upwardly from the other edge of the lower wall portion 14 for abutting against an outer surface of each tooth 12 of such upper row of teeth 30.

There is a lower plate member, generally designated 40, that substantially conforms to the shape of each individual tooth 22 of a lower row of teeth, generally designated 50, of such predetermined individual for press fitting onto and shielding the lower row of teeth 50 of such predetermined individual. The lower plate member 40 includes a substantially horizontal upper wall portion 24 for abutting against a top surface of each individual tooth 22 of such lower row of teeth 50. A substantially vertical first side wall portion extends downwardly from one edge of the upper wall portion 24 for abutting against an inner surface of each tooth 22 of the lower row of teeth 50, and a substantially vertical second side wall portion 28 extends downwardly from other edge of the upper wall portion 24 for abutting against an outer surface of each individual tooth 22 of the lower row of teeth 50.

The preformed teeth guard 10 can be either disposable or reusable. Each of the upper and lower plate members 20 and 40, respectively, is preferably made from a molded plastic material. The characteristics of the molded plastic material can vary dependent on whether the preformed teeth guard 10 is to be disposable or reusable. Obviously, a stronger and more durable material will be used if the preformed teeth guard is to be reusable. Also, the molded plastic material is, preferably, one of transparent and tooth colored.

The reusable preformed teeth guard may further include a container 32 for storing each of upper and lower plate members 20 and 40, respectively, therein when not in use. The container 32, preferably, seals when closed such that if a liquid is placed therein for cleaning the upper and lower plate members 20 and 40, respectively, when not in use, container 32 will not leak.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A preformed teeth guard for at least one of protecting teeth having sensitivity to at least one of hot and cold consumables and preventing teeth from at least one of becoming stained and accumulating harmful particles at least one of thereon and therebetween while drinking and eating, said preformed teeth guard comprising:
(a) an upper plate member substantially conforming to a shape of each individual tooth of an upper row of teeth of a predetermined individual for press fitting onto and shielding such upper row of teeth of such predetermined individual, said upper plate member including;
(i) a substantially horizontal lower wall portion for abutting against a bottom surface of each such individual tooth of such upper row of teeth,
(ii) a substantially vertical first side wall portion extending upwardly from one edge of said lower wall portion for abutting against an inner surface of each such individual tooth of such upper row of teeth, and
(iii) a substantially vertical second side wall portion extending upwardly from other edge of said lower wall portion for abutting against an outer surface of each such individual tooth of such upper row of teeth; and
(b) a lower plate member substantially conforming to a shape of each individual tooth of a lower row of teeth of such predetermined individual for press fitting onto and shielding such lower row of teeth of such predetermined individual, said lower plate member including;
(i) a substantially horizontal upper wall portion for abutting against a top surface of each such individual tooth of such lower row of teeth,
(ii) a substantially vertical first side wall portion extending downwardly from one edge of said upper wall portion for abutting against an inner surface of each such individual tooth of such lower row of teeth, and
(iii) a substantially vertical second side wall portion extending downwardly from other edge of said upper wall portion for abutting against an outer surface of each such individual tooth of such lower row of teeth.

2. A preformed teeth guard, according to claim 1, wherein each of said upper and lower plate members are made from molded plastic material.

3. A preformed teeth guard, according to claim 2, wherein said molded plastic material is one of transparent and tooth colored.

4. A preformed teeth guard, according to claim 1, wherein said preformed teeth guard is disposable.

5. A preformed teeth guard, according to claim 1, wherein said preformed teeth guard is reusable.

6. A preformed teeth guard, according to claim 5, wherein said reusable preformed teeth guard further includes a container for storing each of said upper and lower plate members therein when not in use.

7. A preformed teeth guard, according to claim 6, wherein said container is sealed when closed such that when a liquid is placed therein for cleaning said upper and lower plate members when not in use said container will not leak.
